(19) United States
(12) Patent Application Publication
(10) Pub. No.: US 2024/0072399 A1
(43) Pub. Date: Feb. 29, 2024

(54) DISCONNECTION DEVICE AND SHORT-CIRCUITING DEVICE COMPRISING A HEAT-ACTIVATABLE ELEMENT

(71) Applicant: SAFT, Levallois-Perret (FR)

(72) Inventors: Thierry BERLUREAU, Bordeaux (FR); Gérard RIGOBERT, Fargues St Hilaire (FR); Richard ROY, Pessac (FR)

(73) Assignee: SAFT, Levallois-Perret (FR)

(21) Appl. No.: 17/767,544

(22) PCT Filed: Oct. 15, 2020
(86) PCT No.: PCT/EP2020/079098

§ 371 Date: Apr. 8, 2022

(30) Foreign Application Priority Data
Oct. 18, 2019 (FR) 1911692

(51) Int. Cl. H01M 50/581; H01M 50/521

(52) U.S. Cl. CPC H01M 50/581; H01M 50/521; H01M 2200/103

(57) ABSTRACT

A disconnection device, in particular for disconnecting two electrically connected electrochemical elements. The present invention also relates to a device for short-circuiting two electrodes of opposite polarity in an electrochemical element. The subject matter of the invention includes an assembly comprising: ⋅ a) a connecting part (3) and ⋅ b) a disconnection device (4), the disconnection device being intended to disconnect two electrochemical elements (1, 2) connected by the connecting part (3), the disconnection device (4) comprising: ⋅ i) microparticles (5) capable of expanding when their temperature reaches a threshold value, the threshold value being below 150° C., ⋅ ii) a capsule (4a, 4b) enclosing all of the microparticles (5), the capsule (4a, 4b) being arranged such that when the temperature of the microparticles (5) reaches the threshold value, the expansion of the microparticles disconnects the connection between the two electrochemical elements (1, 2).

### FIELD OF THE INVENTION

The present invention relates to a disconnection device, in particular to a disconnection device adapted to disconnect two electrically connected electrochemical cells one from the other.

The present invention also relates to a device for short-circuiting two electrodes of opposite polarities within an electrochemical cell.

### BACKGROUND ART

An electrochemical cell or electrochemical generator (these two terms being equivalent in the present specification) is an electricity generation device in which chemical energy is converted into electrical energy. The chemical energy is the result of electrochemically active compounds deposited on at least one face of electrodes arranged in the electrochemical generator. Electrical energy is produced by electrochemical reactions during a discharge of the electrochemical generator. Electrodes, disposed in a container, are electrically connected to current output terminals that provide electrical continuity between the electrodes and an electrical consumer to which the electrochemical generator is associated. The positive and negative current output terminals may be attached to either the opposing face walls of the electrochemical generator container or be on the wall of a same face of the container.

A battery generally includes a plurality of electrochemical cells electrically connected to each other, in series or in parallel, by means of metal bars. The metal bars have a cross section sufficient to allow high current flow between the electrochemical cells. The battery also generally comprises an electronic circuit for monitoring and managing the electrochemical cells, for measuring their state of charge and/or their state of health, in particular by means of voltage or current measurements taken individually cell by cell or taken on a group of cells. The battery may also include a temperature control device.

For convenience of electrical connection between the electrochemical cells, the positive and negative current output terminals are often attached to the wall of a same face of the container, often on a lid for closing the container of the cell.

An abnormality in the operation of the battery can be caused by the malfunction of one of the electrochemical cells (short-circuit, overcharge . . . ) or by external disturbance (impact, temperature, etc.) or by a failure of the electronic system managing the state of charge or other parameters of the cells of the battery.

For example, when a lithium electrochemical cell is overcharged, its temperature increases. The increase in temperature results in an increase in the charging current that further promotes temperature rise. If the cell does not have a cooling system sufficient to discharge the heat emitted, a situation of thermal runaway arises: the temperature rise is being spurred on by the cell itself. Uncontrolled increase in cell temperature results in the generation of gas that can result in an increase in internal pressure in the cell, which will result in the gas evacuation safety system opening. In the event of the release of hot gases, the temperature of which can reach 650° C., these gases come into contact with the other to cells of the battery. There is now a risk of the thermal runaway phenomenon propagating to all of the cells of the battery, leading to the total destruction of the battery.

US patent application 2016/0190657, European Patent EP 1,705,735 and European Patent EP 1,126,534 disclose circuit breaker devices for interrupting current flow when the pressure in a cell container reaches a certain value. However, as mentioned above, the increase in pressure occurs at an already advanced stage of thermal runaway so that the pressure is not a parameter for early detection of thermal runaway. In addition, the reliability of this type of device is not satisfactory. Indeed, it has been found that with the passage of time, pressure-sensitive devices are likely to trigger due to the accumulation of gas in the container of the cell, these gases being nevertheless formed during normal operation of the cell. Triggering of this type of device thus leads to disconnection which was not required.

German Patent Application DE 10 2014 200 197 A1 discloses an electrical disconnect device activated by an increase in pressure or temperature. This document discloses a particular embodiment where the device comprises an expansion material whose expansion will indirectly disconnect the electronic circuit board associated with the cell.

That document however discloses neither the nature of this expansion material nor the temperature threshold value starting from which this material expands. However, the nature of this expansion material is a determining factor for the efficacity of the device.

There is therefore a need to provide a more reliable device for early detection of thermal runaway and for effectively inhibiting propagation of the thermal runaway phenomenon.

### SUMMARY OF THE INVENTION

A first subject matter of the invention is an assembly comprising:
a) a connection member and
b) a disconnection device, said disconnection device being configured to disconnect two electrochemical cells connected together by said connection member, said disconnection device comprising:
i) microparticles capable of expanding when the temperature thereof reaches a threshold value, said threshold value being less than 150° C.,
ii) a capsule enclosing said microparticles,
said capsule being arranged such that, when the temperature of the microparticles reaches said threshold value, the expansion of the microparticles leads to disconnection of a connection between said two electrochemical cells.

In one embodiment, the capsule is made of an electrically non-conductive material.

In one embodiment, the microparticles are microspheres.

In one embodiment, the microparticles are not electrically conductive.

According to one embodiment, the connection member comprises at least one region of weakness, and the expansion of the microparticles results in a breakage of the at least one region of weakness, leading to a breaking off of a connection between the two electrochemical cells.

A second subject matter of the invention is a battery comprising:
at least two electrochemical cells, each electrochemical cell comprising at least two current output terminals, and
at least one assembly as described above, the connection member being connected between a current output terminal of a first electrochemical cell and a current output terminal of a second electrochemical cell.

A third subject matter of the invention is an electrochemical cell comprising:
a) at least two current output terminals of opposite polarities, and
b) a device for short-circuiting said two terminals of opposite polarities, said device comprising:
i) microparticles capable of expanding when the temperature thereof reaches a threshold value, said threshold value being less than 150° C.,
ii) a capsule enclosing said microparticles,
said capsule being arranged such that, when a temperature of the microparticles reaches said threshold value, expansion of the microparticles leads to connection of said two terminals of opposite polarities.

In one embodiment, the electrochemical cell as defined above includes a fuse, connected between the two terminals of opposite polarity.

In one embodiment, the capsule is made of an electrically conductive material or is made of an electrically non-conductive material, said electrically non-conductive material being either covered with an electrically conductive coating or is in contact with an electrically conductive member.

According to one embodiment, the capsule is made of an electrically conductive material or is made of an electrically non-conducting material, said electrically non-conducting material is either covered with an electrically conductive coating or is in contact with an electrically conductive member.

In one embodiment, the electrically conductive material of said capsule is selected from aluminum, copper and stainless steel.

In one embodiment, the electrically non-conductive material of the capsule is a plastics material.

In one embodiment, the electrically conductive member is a metal bimetal.

In one embodiment, the electrically conductive member is made of a shape memory material.

In one embodiment, the electrochemical cell as defined above comprises:
a) a container comprising an opening for introducing an electrode plate group, and
b) a cover placed onto said opening,
wherein the at least two current output terminals of opposite polarities and the device for short-circuiting are placed on or through the cover.

In one embodiment, one of the at least two current output terminals is in direct contact with the cover and an opposite polarity terminal is electrically insulated from the cover.

According to an embodiment, the electrochemical cell as defined above is of a liquid or solid electrolyte lithium-ion type, a liquid or solid electrolyte lithium-metal type, a nickel metal-hydride or a nickel cadmium type.

The invention further provides a battery comprising the electrochemical cell as disclosed above and corresponding to the third subject matter of the invention.

The first and third subject matters of the invention constitute two alternative solutions to the same technical problem. In fact, both allow early detection of the occurrence of thermal runaway and thus prevent its propagation.

### BRIEF DESCRIPTION OF THE DRAWINGS

FIG. 1a is a diagrammatic representation of the battery, which is the second subject matter of the invention. The battery includes the assembly formed by the connection member and the disconnecting device.

FIG. 1b shows the effect of the expansion of the microparticles according to a particular embodiment of said assembly, which is the first subject matter of the invention.

FIG. 2a shows another embodiment of the disconnect device in which the capsule is in a cavity formed in the connection member.

FIG. 2b shows the effect of the expansion of the microparticles in the case of the embodiment of FIG. 2a.

FIG. 3 is a diagrammatic representation of the electrochemical cell according to the invention. The cell includes the device for short-circuiting.

### DETAILED DESCRIPTION OF EMBODIMENTS

The assembly and electrochemical cell according to the invention have increased reliability and enable early detection of thermal runaway in comparison with prior art devices for the following reasons:
the disconnection device and the device for short-circuiting are directly activated by an increase in temperature and not by an increase in pressure. Indeed, as mentioned above, the increase in pressure occurs at an already advanced stage of thermal runaway so that the pressure is not a parameter making it possible to prevent the occurrence of thermal runaway sufficiently early. In addition, as previously mentioned, it has been found that with the passage of time, pressure-sensitive devices are likely to trigger even though the cell has normal operation thereby causing disconnection that was not required.
the microparticles comprised in the disconnection device and the device for short-circuiting are able to expand when the temperature reaches a threshold value, said threshold value being less than 150° C., where the expandable materials used in the prior art devices expand from a threshold value greater than that of the present invention. As a result, the microparticles make it possible to trigger said devices sufficiently early in order to be able to prevent the propagation of thermal runaway.

The term “disconnection device” means a device for electrically disconnecting at least two electrochemical cells connected together by a connection member.

The term “connection member” means any part making it possible to ensure the passage of current and connecting at least two electrochemical cells to each other. The connection member may in particular be in the form of a metal strip.

The term “capsule” means a member consisting of two parts:
a container-forming part for containing said microparticles,
a part forming a closure part, such as a cover.

The two parts of the capsule can be joined together by heat-welding, by crimping or by bonding.

Each microparticle may have any shape. Each microparticle may in particular have a solid tube shape or solid sphere shape. Preferably, the microparticles are microspheres.

Each microparticle may have a volume equivalent to the volume of a solid sphere having a diameter d₁ ranging from 10 to 50 pm when the temperature of the microparticle is less than said threshold value and a volume equivalent to the volume of a solid sphere of a diameter d₂ which is 3 to 5 times greater than the diameter d₁ when the temperature of the microparticle is greater than or equal to said threshold value. The diameter d₂ may range from 30 to 250 μm.

When the temperature of the microparticles reaches said threshold value, the total volume of the microparticles can increase in a ratio ranging from 9 to 125.

Such microparticles are available from the Kureha company.

Said threshold value may be 140° C., 130° C., 120° C., 110° C., 100° C., 90° C. or 80° C. Preferably, said threshold value may be between 80 and 120° C.

The capsule surrounding the microparticles may be made of an electrically non-conductive material. The non-conductive material may be of a plastic material.

The capsule may be made of a material capable of deforming upon expansion of the microparticles, the deformation of the capsule causing the connection member to break. The expansion of the microparticles occurs as soon as the temperature reaches said threshold value, and as soon as the threshold value is exceeded, the contents of the capsule will expand abruptly until the connection member breaks.

The suddenness of the expansion of the capsule means that the capsule can expand within a period of less than ten seconds, preferably less than five seconds.

The capsule included in the first subject matter of the invention may be disposed on a support. The support may be formed by an insulating member attached to the connection member that connects the electrochemical cells to each other.

In another embodiment, the connection member may serve as a support for the capsule. In this case, the connection member is arranged in such a way that it comprises a cavity for containing said capsule.

The pressure that can be exerted on the connection member by the expansion of the microparticles ranges from 0.5 N/mm² to 1.2 N/mm².

The connection member can have at least one region of weakness and the expansion of the microparticles can cause a breakage of the at least one region of weakness, leading to rupture of a connection between the two electrochemical cells. The at least one region of weakness may be obtained by locally reducing the thickness of the connection member.

The microparticles may not be electrically conductive.

According to the invention, the threshold value is less than 150° C. A threshold value greater than or equal to 150° C. does not allow sufficiently rapid triggering of the device. The invention therefore excludes expandable graphite that expands when its temperature reaches a threshold value greater than 150° C.

The invention also relates to a battery comprising:
at least two electrochemical cells, each electrochemical cell comprising at least two current output terminals, and
at least one assembly as disclosed above, wherein the connection member is connected between a current output terminal of a first electrochemical cell and a current output terminal of a second electrochemical cell.

In one embodiment, the at least two electrochemical cells may be of cylindrical or prismatic format.

The assembly according to the invention applies to all types of electrochemical cells, more particularly to electrochemical cells of the lithium-ion with a liquid or solid electrolyte, lithium-metal with a liquid or solid electrolyte, nickel metal-hydride or nickel cadmium type.

A third subject matter of the invention is an electrochemical cell comprising:
a) at least two current output terminals of opposite polarities, and
b) a device for short-circuiting the two terminals of opposite polarities, said device comprising:
i) microparticles capable of expanding when the temperature thereof reaches a threshold value, said threshold value being less than 150° C.,
ii) a capsule enclosing said microparticles, said capsule being arranged such that, when the temperature of the microparticles reaches said threshold value, the expansion of the microparticles leads to connection of said two terminals of opposite polarities.

The term “device for short-circuiting” means a device making it possible to electrically contact two terminals of opposite polarities of a same cell.

The microparticles used in the electrochemical cell according to the third subject matter of the present invention have the same technical features as those disclosed above in the context of the assembly which is the first subject matter according to the invention.

The electrochemical cell which is the third subject matter of the invention comprises means for interrupting the passage of a current in the cell when the current exceeds a determined value. The means may be a fuse connected between the two terminals of opposite polarities. The fuse may be connected in series with the electrode plate group.

The capsule of the electrochemical cell which is the third subject matter of the invention, may be made of a material capable of deforming upon expansion of the microparticles, the deformation of the capsule resulting in electrical continuity between the two terminals of opposite polarity of the cell.

The capsule of the electrochemical cell may be made of an electrically conductive material. The electrically conductive material may be selected from aluminum, copper, and stainless steel.

In another embodiment, the capsule may be made of an electrically non-conductive material covered with an electrically conductive coating. The electrically non-conductive material may be a plastic material. Preferably, the plastic material is a polyimide film)(Kapton®). A conductive material is applied to the plastic capsule for example by spraying.

When the capsule is made of a non-conductive material, the electrochemical cell according to the invention may further comprise an electrically conductive member in contact with said capsule, the deformation of the capsule causing the electrically conductive member to move. This movement causes the two terminals of opposite polarities to be short-circuited. The electrically conductive member may be a metal bimetal. The electrically conductive member may be formed of a shape memory material.

The capsule of the electrochemical cell may be placed on a support. In a particular embodiment, the cover of the electrochemical cell has a cavity in which the capsule is housed.

The electrochemical cell as disclosed above, which is the third subject matter of the invention may comprise:
a) a container comprising an opening for introducing an electrode plate group, and
b) a cover placed on said opening,
wherein the at least two current output terminals of opposite polarities and the device for short-circuiting are placed on or through the cover.

In one embodiment, one of the at least two current output terminals may be in direct contact with the cover. The positive terminal may be in direct contact with and at the same potential as the cover. The negative terminal may be electrically insulated from the cover. Conversely, the positive terminal may be electrically insulated from the cover and the negative terminal may be in direct contact with and at the same potential as the cover.

According to one embodiment, the electrochemical cell according to the invention may be of the lithium-ion with a liquid or solid electrolyte, lithium metal with a liquid or solid electrolyte, nickel metal-hydride or nickel cadmium type.

According to one embodiment, the electrochemical cell according to the invention may be of cylindrical, prismatic or pouch-like format (a pouch cell).

The invention also provides as a fourth subject matter a battery comprising at least one electrochemical cell as defined above which is the third subject matter of the invention.

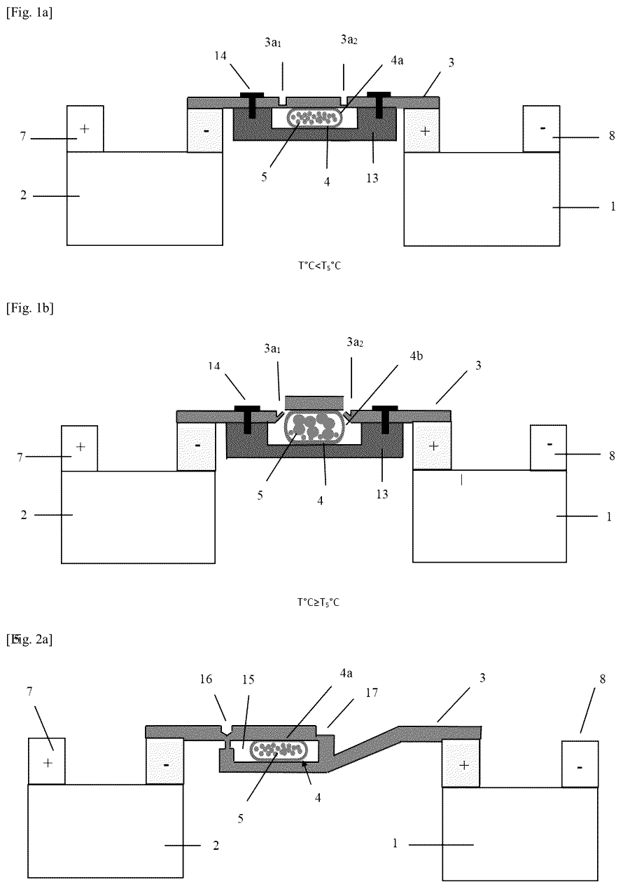

The present invention will be better understood with reference to FIGS. 1a to 3.

In FIG. 1a, the disconnection device comprised in the assembly, which is the first subject matter of the invention, is configured to disconnect two electrochemical cells 1, 2 connected together by a connection member 3. The connection member comprises two regions of weakness 3a₁, 3a₂. Each region of weakness consists of a thinning of the connection member 3. It will be understood that the present invention can also be implemented in the case where the connection member comprises a single region of weakness.

Each cell comprises a positive current output terminal 7 and a negative current output terminal 8. A capsule 4 containing microparticles 5 is placed in contact with the lower surface of the connection member. When the temperature of the microparticles 5 is less than a threshold value which itself is less than 150° C., the capsule 4 which rests on a support 13, occupies a neutral position 4a and the microparticles each have a volume equivalent to the volume of a solid sphere of a diameter d₁ ranging from 10 to 50 μm. The support is fixed to the connection member by means of fastening means, for example a screw 14.

In FIG. 1B, when the temperature of the microparticles 5 reaches said threshold value which may be between 80 and 149° C., preferably between 80 and 120° C., then the microparticles expand to each occupy a volume equivalent to that of a solid sphere of a diameter d₂ which is 3 to 5 times greater than the diameter d₁.

The expansion of the microparticles 5 results in the deformation of the capsule 4 which then occupies the position 4b. The capsule in position 4b therefore exerts a pressure on the connection member 3. In the particular embodiment disclosed in FIG. 1b, the capsule at position 4b exerts a pressure in the vicinity of the regions of weakness 3a₁ and 3a₂ of connection member 3. This pressure is such that it ruptures connection member 3 and thus breaks the connection between the two electrochemical cells 1 and 2.

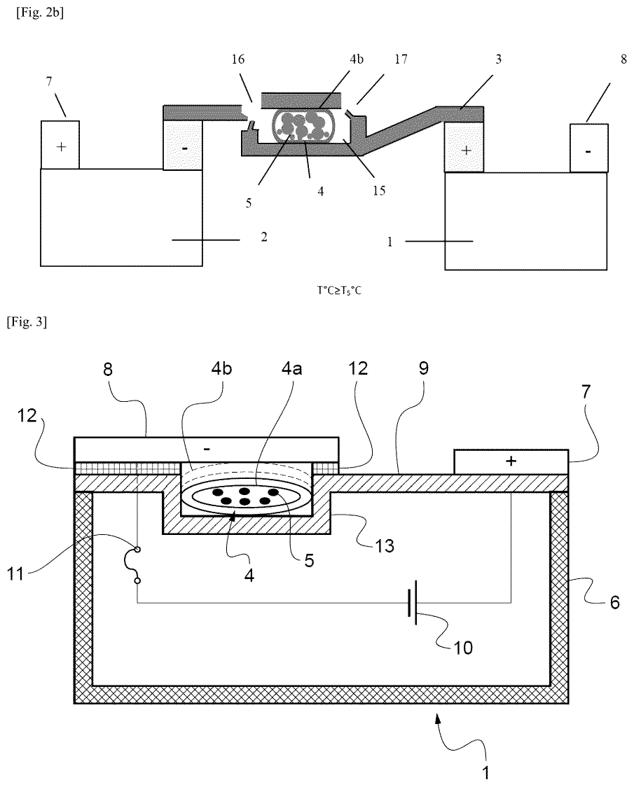

FIGS. 2a and 2b illustrate another embodiment of the disconnecting device in which the capsule 4 is located in a cavity 15 provided in the connection member 3. The walls of the cavity have two regions of weakness 16, 17. When the temperature of the microparticles 5 reaches said threshold value, the capsule exerts a pressure in the vicinity of the two regions of weakness 16, 17 thereby causing the connection member to break consequently interrupting the electrical connection between the two electrochemical cells 1 and 2.

The operation of the device for short-circuiting included in the electrochemical cell, the third subject matter of the invention, is illustrated by a particular embodiment as shown in FIG. 3. The electrochemical cell 1 as shown in FIG. 3 comprises:
a container 6,
a positive terminal 7 and a negative terminal 8,
a cover 9,
an electrode plate group or plate set 10,
a fuse 11,
a capsule 4 comprising the microparticles 5,
a layer of an electrical insulator 12.

In this particular embodiment, the capsule 4 is positioned in a recess of the cover 9. The recess thus forms a support 13. The container 6 and the cover 9 are at the same potential as the positive terminal 7. An electrically insulating layer 12 on the cover 9 insulates the negative terminal 8 from the cover. When the temperature of the microparticles 5 is less than a threshold value which itself is less than 150° C., the capsule 4 occupies a neutral position 4a and the microparticles each have a volume equivalent to the volume of a solid sphere of a diameter d₁ ranging from 10 to 50 μm. When the temperature of the microparticles 5 reaches said threshold value which may be between 80 and 149° C., preferably between 80 and 120° C., then the microparticles expand to each occupy a volume equivalent to the volume of a solid sphere of a diameter d₂ which is 3 to 5 times greater than the diameter d₁. The expansion of the microparticles thus results in the deformation of the capsule 4 which then occupies the position 4b. When the capsule occupies the position 4b, it is directly in contact with the negative terminal 8. In this embodiment, the capsule 4 is made of an electrically conductive material, so that the electric current is diverted to pass through the capsule 4 until it reaches the positive terminal 7 thereby creating a short circuit and blowing the fuse 11. Blowing of the fuse 11 interrupts the flow of current in the electrochemical cell thereby preventing the occurrence of possible thermal runaway.

1. An assembly comprising:
a) a connection member and
b) a disconnection device said disconnection device being configured to disconnect two electrochemical cells connected together by said connection member, said disconnection device comprising:
i) microparticles capable of expanding when the temperature thereof reaches a threshold value, said threshold value being less than 150° C.,
ii) a capsule enclosing said microparticles,
said capsule being arranged such that, when a temperature of the microparticles reaches said threshold value, expansion of the microparticles leads to disconnection of a connection between said two electrochemical cells.

2. The assembly of claim 1, wherein said capsule is made of an electrically non-conductive material.

3. The assembly of claim 1, wherein the microparticles are microspheres.

4. The assembly of claim 1, wherein the microparticles are not electrically conductive.

5. The assembly according to claim 1, wherein the connection member comprises at least one region where it is fragile, and the expansion of the microparticles results in a breakage of the at least one region where the connection member is fragile, leading to a breaking off of the connection between the two electrochemical cells.

6. A battery comprising:
at least two electrochemical cells, each electrochemical cell comprising at least two current output terminals, and
at least one assembly comprising:
a) a connection member and
b) a disconnection device said disconnection device being configured to disconnect two electrochemical cells connected together by said connection member, said disconnection device comprising:
i) microparticles capable of expanding when the temperature thereof reaches a threshold value, said threshold value being less than 150° C.,
ii) a capsule enclosing said microparticles,
said capsule being arranged such that, when a temperature of the microparticles reaches said threshold value, expansion of the microparticles leads to disconnection of a connection between said two electrochemical cells,
the connection member being connected between a current output terminal of a first electrochemical cell and a current output terminal of a second electrochemical cell.

7. An electrochemical cell comprising:
a) at least two current output terminals of opposite polarities, and
b) a device for short-circuiting said two terminals of opposite polarities, said device comprising:
i) microparticles capable of expanding when the temperature thereof reaches a threshold value, said threshold value being less than 150° C.,
ii) a capsule enclosing said microparticles,
said capsule being arranged such that, when a temperature of the microparticles reaches said threshold value, expansion of the microparticles leads to connection of said two terminals of opposite polarities.

8. The electrochemical cell according to claim 7, comprising a fuse, connected between the two terminals of opposite polarity.

9. The electrochemical cell according to claim 7, wherein said capsule is made of an electrically conductive material or is made of an electrically non-conductive material, said electrically non-conductive material being either covered with an electrically conductive coating or is in contact with an electrically conductive member.

10. The electrochemical cell of claim 9, wherein the electrically conductive material of said capsule is selected from aluminum, copper and stainless steel.

11. The electrochemical cell of claim 9, wherein the electrically non-conductive material of said capsule is a plastics material.

12. The electrochemical cell of claim 9, wherein the electrically conductive member is a metal bimetal.

13. The electrochemical cell of claim 9, wherein the electrically conductive member is made of a shape memory material.

14. The electrochemical cell according to claim 7, comprising:
a) a container comprising an opening for introducing an electrode plate group, and
b) a lid placed over said opening,
wherein said at least two current output terminals of opposite polarities
and the device for short-circuiting are placed on or through a cover.

15. The electrochemical cell of claim 14, wherein one of the at least two current output terminals is in direct contact with the cover and an opposite polarity terminal is electrically insulated from the cover.

16. The electrochemical cell according to claim 7, of a liquid or solid electrolyte lithium-ion type, a liquid or solid electrolyte lithium-metal type, a nickel metal-hydride or a nickel cadmium type.

17. A battery comprising at least one electrochemical cell according to claim 7.
